(19) United States
(12) Patent Application Publication
(10) Pub. No.: US 2014/0004394 A1
(43) Pub. Date: Jan. 2, 2014

(54) battery thermal management using phase change material

(71) Applicant: Ingo Kerkamm, Stuttgart-Rohr (DE)

(72) Inventor: Ingo Kerkamm, Stuttgart-Rohr (DE)

(21) Appl. No.: 13/978,754

(22) PCT Filed: Jan. 4, 2012
(86) PCT No.: PCT/EP12/50063

§ 371 Date: Sep. 23, 2013

(30) Foreign Application Priority Data
Jan. 12, 2011 (DE) 10 2011 002 549.9

(51) Int. Cl. H01M 10/50

(52) U.S. Cl. CPC H01M 10/50
USPC 429/50; 429/120

(57) ABSTRACT

A device for thermal management of a battery, including a battery and a latent heat storage material, which may change its phase from liquid to solid, and which may give off heat of crystallization in the process to heat up the battery, and the crystallization may be triggered by a pulse.

### FIELD OF THE INVENTION

The present invention relates to a device for thermal management of a battery, including a battery and a latent heat storage material, which may change its phase from liquid to solid, and which may give off heat of crystallization in the process to heat up the battery and the crystallization may be triggered by a pulse. The present invention also relates to products, including this device and a method for the thermal management of batteries.

### BACKGROUND INFORMATION

The usable capacity and power of various lithium ion batteries is believed to be greatly influenced by the ambient temperature of the component. Therefore, at low ambient temperatures in particular, it is necessary to heat the battery to almost room temperature, i.e., 18° C. to 20° C., before or directly during the operation. For this purpose, separate heating systems are heated up, if necessary, in combination with an additional battery based on a different chemical reaction (e.g., lead-acid).

The principle of using the heat of crystallization released by crystallization of a material for heating purposes is known from gel hand warmers, for example. In the case of a gel hand warmer, crystallization may be initiated by a bendable small metal plate, for example.

### SUMMARY OF THE INVENTION

An object of the present invention is a device 1 for thermal management of a battery, including a battery 2, and a latent heat storage material 3, which may change its phase from liquid to solid and give off heat of crystallization in the process to heat up a battery 2 and the crystallization is triggered by a pulse.

The object of the present invention is also a device 1 for thermal management of a battery, including a battery 2 and a latent heat storage material 3, which may absorb excess heat from battery 2 and thereby change its phase from solid to liquid and thus cool battery 2.

In one specific embodiment of the present invention, the device is characterized in that latent heat storage material 3 is a gel.

In one specific embodiment of the present invention, the device is characterized in that latent heat storage material 3 is situated in a housing 4, which is placed around battery 2. The housing may completely enclose the battery. The housing may enclose only parts of the battery.

In another specific embodiment, the device is characterized in that latent heat storage material 3 is situated in multiple separate housings 4, which are placed around battery 2. In a special specific embodiment, the device is characterized in that the phase change of latent heat storage material 3 in separate housings 4 may be controlled independently of one another.

In a further specific embodiment, the device is characterized in that latent heat storage material 3 is located directly in battery 2.

Another aspect of the present invention relates to a product which is characterized in that it includes a device according to the present invention. In a special specific embodiment of the present invention, the product is a piece of equipment or a vehicle.

Another aspect of the present invention relates to a method for thermal management of a battery and is characterized in that a battery 2 is brought into contact with a latent heat storage material 3, and the battery is heated by the fact that latent heat storage material 3 is in a liquid phase, and latent heat storage material 3 may change its phase from liquid to solid and give off heat of crystallization in the process to heat up battery 2, the crystallization of latent heat storage material 3 being triggered by a pulse and the battery being cooled by the fact that latent heat storage material 3 is in a solid phase, and latent heat storage material 3 may absorb heat and thereby change its phase from solid to liquid.

Another aspect of the present invention relates to a method for heating a battery 2 and is characterized in that a battery 2 is brought into contact with a latent heat storage material 3, and latent heat storage material 3 is in a liquid phase, and latent heat storage material 3 may change its phase from liquid to solid and give off heat of crystallization in the process to heat up battery 2, the crystallization of latent heat storage material 3 being triggered by a pulse.

Another aspect of the present invention relates to a method for cooling a battery 2 and is characterized in that a battery 2 is brought into contact with a latent heat storage material 3, latent heat storage material 3 is in a solid phase and latent heat storage material 3 may absorb heat, thereby changing its phase from solid to liquid.

The present invention utilizes the heat of crystallization released during crystallization of a latent heat storage material 3 to heat up a battery 2 at a low ambient temperature to an optimum operating temperature. The heat of crystallization thereby released may be utilized for heating a battery 2 to a temperature range for operation of the battery (for example, 18° C., 19° C., 20° C., 40° C., 60° C.). The temperature range here depends on the cell chemistry and the type of battery used.

If battery 2 is to be activated after a lengthy standing time at low temperatures, the crystallization of latent heat storage material 3 may be initiated by a suitable pulse (trigger), whereupon this releases its thermally stored energy in the form of heat of crystallization and thereby heats up battery 2.

Electrochemical cells are electrochemical energy stores and energy converters. When an electrochemical cell is discharged, stored chemical energy is converted into electrical energy by the electrochemical redox reaction. Primary cells may be discharged only once and cannot be recharged. The reactions during discharging are partially irreversible in these cells. However, rechargeable secondary batteries have to be largely returned to the charge state resembling the new state, so that repeated conversion of chemical energy into electrical energy and vice versa is possible. In the present patent application, the term battery is used as a generic term for battery, electrochemical cell and rechargeable battery.

The capacitance is reported in ampere hours (abbreviation: Ah) or in ampere seconds=Coulomb (unit symbol: C). The capacitance of a battery is the electrical charge stored in the battery. A distinction is made between the theoretical capacitance (which depends on the amount of active material in the battery) and the charge which is obtainable under certain conditions (usable capacitance). The usable capacitance of a battery depends on the discharge conditions, for example, the temperature and history of the battery (for example, the duration and conditions of storage prior to discharge).

All batteries are subject to self-discharge during storage. The rate of self-discharge depends among other things on the type of battery and the temperature. The lower the storage temperature, the lower is the self-discharge. It may therefore be advantageous to store the battery at a low temperature and bring it to the optimum operating temperature shortly before use.

A lithium battery is a primary cell, in which lithium is used as the active material in the negative electrode. It is not configured to be rechargeable, in contrast with the lithium ion battery. The latter are frequently also referred to as lithium batteries. Examples of lithium batteries include the lithium-thionyl chloride battery, the lithium-manganese dioxide battery, the lithium-sulfur dioxide battery, the lithium-carbon monofluoride battery, the lithium-iodine battery, the lithium-iron sulfide battery.

Examples of other batteries include the alkali-manganese battery, the nickel-oxyhydroxide battery, the mercury-oxide-zinc battery, the silver oxide-zinc cells, the zinc-manganese dioxide cell, the zinc chloride battery, the zinc-air battery.

A rechargeable battery is a repeatedly reusable storage device for electrical energy, usually based on an electrochemical system, and is thus a special type of battery. In contrast with a nonrechargeable battery containing primary cells, a rechargeable battery has one or multiple rechargeable secondary cells. Rechargeable batteries are used as the starter battery in vehicles to generate electricity for light, for the on-board electronic systems and for the starter for starting the internal combustion engine. Rechargeable batteries supply electricity until the engine is running, then the rechargeable battery is recharged again via the alternator, which operates as a generator. Similarly rechargeable batteries may be used in motorcycles, boats and aircraft.

Examples of rechargeable batteries include the NiCd (nickel-cadmium) battery, the NiH₂ (nickel-hydrogen) battery, the NiMH (nickel-metal hydride) battery, the NiFe (nickel-iron) battery, the Li ion (lithium ion) battery, the LiPo (lithium-polymer) battery, the LiFe (lithium-metal) battery, the LMP (lithium-metal-polymer) battery, the Li—Mn (lithium-manganese) battery, the LiFePO₄ (lithium-iron-phosphate) battery, the LiTi (lithium-titanate) battery, the LiS (lithium-sulfur) battery, the RAM (rechargeable alkaline manganese) battery, the PTMA (2,2,6,6-tetramethylpiperidineoxy-4-yl methacrylate) battery, the Na/NiCl (high-temperature sodium-nickel chloride) battery, the SCiB battery (super charge ion battery), the SnC/Li₂S (tin-sulfur-lithium) battery, the silver-zinc battery, the vanadium-redox battery, the zinc-bromine battery.

In the simplest specific embodiment, latent heat storage material 3 is situated around battery 2. The latent heat storage material is a storage material which may change its phase from liquid to solid and vice versa, thereby releasing or absorbing energy. Latent heat storage material 3 may be situated in one or multiple containers, for example, one or multiple housings 4, one or multiple films to retain latent heat storage material 3 in the liquid phase. Latent heat storage material 3 is in a container made of pure plastic, for example, or a container made of a plastic containing additives (for example, ceramic particles) to increase the thermal conductivity, or a container made of metal, which may have a high thermal conductivity (e.g., copper, aluminum) and may additionally have a low density, if necessary.

The latent heat storage material is in the form of a liquid, which undergoes a phase change during cooling. In most cases, saline water or a special gel having a high heat storage coefficient is used as the material for the latent heat storage material. In this case, the phase change is detectable by the fact that the latent heat storage material is hard and thick when charged (i.e., cooled). A substance which prevents decay may be added to the latent heat storage material.

Latent heat storage materials 3 function by utilizing the enthalpy of reversible thermodynamic phase changes of the storage material, which may be the phase transition from solid to liquid (solidification/melting). Latent heat storage materials contain, for example, special salts or paraffins as the contents, which function as the storage medium. During charging of the storage material of latent heat storage material 3, the storage material is melted and thus may absorb a great deal of thermal energy (melting heat). This process is reversible. During solidification, the storage material releases precisely this quantity of heat again.

For example, Glauber's salt or alum or sodium acetate trihydrate may be used as the storage medium in latent heat storage materials. Sodium acetate trihydrate, for example, is liquefied at a melting point of 58° C. and remains liquid even at much lower temperatures—under some circumstances down to −20° C.—and exists there as a supercooled melt in a metastable state.

The crystallization may be triggered by a pulse, for example, a small metal plate which is pressed into the latent heat storage material. The latent heat storage material heats up during this process, and the complete crystallization and thus the release of the latent heat may continue over a prolonged period of time.

In the present invention, events or materials which trigger the crystallization of the latent heat storage material are referred to as pulses or triggers. Examples of triggers include small plates that may be pressed into the latent heat storage material. Triggers are also crystallization seeds which are added to the latent heat storage material. Triggers may be pressure waves which trigger crystallization in the supersaturated solution of the latent heat storage material. Compression of the latent heat storage material may also trigger crystallization.

The advantage of this heat storage technology is based on storing as much thermal energy as possible in the smallest possible mass in a temperature range which is defined precisely by the melting temperature of the latent heat storage material used. For technical applications of liquid-crystal latent heat storage materials, recrystallization just below the melting temperature is usually desired.

Modern latent heat storage materials based on salt or paraffin have physical properties which have been developed for various applications and are obtainable for almost all temperature ranges. These materials are being used to an increasing extent and permit buffering of the temperature in the range of the optimal operating temperature of the battery, both up and down.

Crystallization refers to the process of forming crystals from a supersaturated solution. In order for a crystal to be able to form, the substance to be crystallized out must first be brought to supersaturation. This takes place, for example, by cooling solutions or melts or by evaporation of the solvent. In the case of crystals which contain multiple components (for example, ionic crystals), supersaturation may also be achieved by mixing two solutions, each of which contains one of the components. The molecules or elements dissolved previously take on a regular, partly substance-specific form. This process may be accelerated by adding seed crystals, which then continue to grow in the supersaturated solution. Supercooling to −30° C. before the water molecules form a crystal lattice is possible without “addition sites,” i.e., without a crystallization seed. For example, crystallization may then be triggered spontaneously by vibration.

Heat of crystallization (heat of solidification) is released when a substance changes its phase from liquid to solid. Due to the law of conservation of energy, the energy released is equal to the energy to be expended to melt the substance (see also melting heat). The solidification heat (=melting heat) per kilogram of mass varies for different substances.

Additional advantages and advantageous embodiments of the subject matters according to the present invention are illustrated by the drawings and explained in greater detail below. It should be pointed out that the drawing has only a descriptive character and is not intended to restrict the present invention in any way.

### BRIEF DESCRIPTION OF THE DRAWING

FIG. 1 shows the schematic configuration of a device 1 for thermal management of a battery.

### DETAILED DESCRIPTION

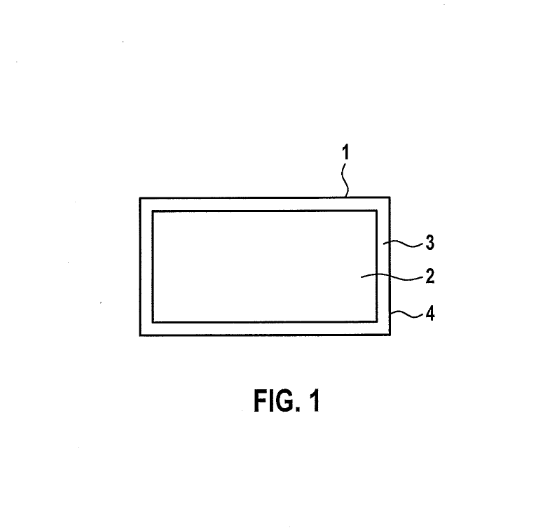

FIG. 1 shows a device 1 for thermal management of a battery, having a battery 2, a latent heat storage material 3 and a housing 4. In the simplest specific embodiment here, latent heat storage material 3 is situated around battery cell 2. The latent heat storage material is a storage material which may change its phase from liquid to solid and vice versa and release or absorb energy in the process. Latent heat storage material 3 may be situated in one or multiple containers, for example, one or multiple housings 4, one or multiple films to retain latent heat storage material 3 in the liquid phase.

The operating mode “device 1 for battery thermal management” is as follows:

Device 1 for thermal management of a battery has a cooling function, on the one hand.

When the battery is in operation, the battery generates energy. Most of the energy is consumed. Some of the energy is converted into heat. The thermal energy is delivered by the battery to the latent heat storage material which surrounds the battery. The latent heat storage material absorbs the thermal energy. The input of heat causes a phase transition to occur in the latent heat storage material, so that the phase of the latent heat storage material changes. The storage material which was previously solid changes to the liquid phase. Absorbing the excess heat of the battery by the latent heat storage material results in melting of the storage material and the battery is cooled by the release of heat.

On the other hand, device 1 for thermal management of a battery has a heating function.

When battery 2 is not in operation or is turned off, no energy is generated by battery 2. Latent heat storage material 3 is in the liquid phase. Crystallization of latent heat storage material 3 is triggered by a pulse. A phase transition from the liquid phase to the solid phase then takes place in the latent heat storage material. During crystallization, the heat of crystallization is released and is absorbed by battery 2 bordering latent heat storage material 3. This causes the battery to heat up and the device acts as a heating element.

The device and the heat of crystallization released by the latent heat storage material may be used to heat or preheat the battery.

Housing 4 may be configured in such a way that the latent heat storage material is stored in several separate housings. The individual housings may be controlled jointly. In a specific embodiment, the individual housings may be controlled independently of one another. This means that crystallization may be triggered independently in the individual housings.

This means that the pulses may be triggered independently of one another in the individual housings. The quantity of heat released may be adjusted in this way, based on the number of triggered crystallization processes or the number of controlled housings or the number of controlled latent heat memory materials. Regardless of the starting temperature being too low, the optimum operating temperature of the battery may be set in this way. The thermally managed battery may be using a plurality of small housings which contain the latent heat memory materials and surround the battery, and the temperature of the battery may be set exactly, if necessary.

To be able to achieve better heating directly at the battery, the latent heat storage material may also be applied to the battery. The latent heat storage material may be then located in small interspaces in the battery.

Crystallization of the latent heat storage material and thus the heating function of device 1 for thermal management of a battery are not triggered when the ambient temperature is high enough. Latent heat storage material 3 then remains deactivated and does not heat the battery.

Device 1 according to the present invention for thermal management of a battery may be used with all batteries which are used under mobile or stationary conditions, regardless of the chemical composition.

The present invention also includes products which include device 1 for thermal management of a battery, for example, equipment and vehicles.

Device 1 for thermal management of a battery may be used in all equipment in which a battery is to operate at a certain temperature, for example, in motor vehicles, in stationary energy stores (for example, in conjunction with photovoltaic systems or wind power plants) or in power tools.

A particular specific embodiment of the present invention relates to the use of device 1 for thermal management of a battery in vehicles, e.g., automobiles, boats, aircraft, motorcycles.

The advantages of device 1 according to the present invention for thermal management of a battery include the fact that an automobile is able to start at very low temperatures without necessitating an energy-intensive preheating of the battery with the aid of a separate system. This reduces the energy consumption for preheating the battery at low ambient temperatures. With the device, faster heating of the battery may be achieved and the warm-up phase is shortened. With the device, operation of the battery in the optimal temperature range may be ensured. The lifetime of the battery may therefore be increased. An additional battery heater is redundant, as the case may be. This lowers manufacturing and repair costs.

The present invention is verifiable easily and unambiguously by a visual arrangement or by a simple measuring technique on the product through the use of a coolant/heating medium with latent heat storage materials.

1-10. (canceled)

11. A device for thermal management of a battery, comprising:
a battery; and
a latent heat storage material, which may change its phase from liquid to solid and which may give off heat of crystallization in the process to heat up the battery, the crystallization being triggerable by a pulse.

12. A device for thermal management of a battery, comprising:
a battery; and
a latent heat storage material, which may absorb excess heat of the battery and, in the process, change its phase from solid to liquid and thus cool the battery.

13. The device of claim 11, wherein the latent heat storage material is a gel.

14. The device of claim 11, wherein the latent heat storage material is located in a housing, which is situated around the battery.

15. The device of claim 11, wherein the latent heat storage material is located in several separate housings which are situated around the battery.

16. The device of claim 15, wherein the phase change of the latent heat storage material is controllable independently of one another in the separate housings.

17. The device of claim 11, wherein the latent heat storage material is situated directly in the battery.

18. A product, comprising:
a device for thermal management of a battery, including:
a battery; and
a latent heat storage material, which may change its phase from liquid to solid and which may give off heat of crystallization in the process to heat up the battery, the crystallization being triggerable by a pulse.

19. A method for heating a battery, the method comprising:
bringing the battery into contact with a latent heat storage material, and the latent heat storage material is in a liquid phase, and the latent heat storage material may change its phase from liquid to solid and give off heat of crystallization in the process to heat up the battery; and
triggering a crystallization of the latent heat storage material by a pulse.

20. A method for cooling a battery, the method comprising:
bringing the battery into contact with a latent heat storage material, the latent heat storage material being in a solid phase and the latent heat storage material may absorb heat and change its phase from solid to liquid in the process.
